(19) United States
(12) Patent Application Publication
(10) Pub. No.: US 2012/0024828 A1
(43) Pub. Date: Feb. 2, 2012

(54) METHOD OF HYBRID WELDING AND HYBRID WELDING APPARATUS

(75) Inventors: Katsura Oowaki, Yokohama-shi (Kanagawa) (JP); Fumio Matsuzaka, Tokyo (JP); Shuichi Fujita, Yokohama-shi (Kanagawa) (JP); Kotaro Inose, Tokyo (JP)

(73) Assignees: IHI CORPORATION, Tokyo (JP); IHI INSPECTION & INSTRUMENTATION CO., LTD., Tokyo (JP)

(21) Appl. No.: 13/263,602

(22) PCT Filed: Apr. 21, 2010
(86) PCT No.: PCT/JP2010/057089

§ 371 Date: Oct. 7, 2011

(30) Foreign Application Priority Data
Apr. 22, 2009 (JP) 2009-103874

(51) Int. Cl. B23K 26/00

(52) U.S. Cl. 219/121.64

(57) ABSTRACT

There are provided a laser diode, an irradiating section that applies an output from the laser diode to a base material in the form of a laser beam and thus melts the surface of the base material while moving the laser beam; a wire feeding section that continuously feeds welding wire to a melted portion of the surface of the base material moving along with the movement of the laser beam emitted from the irradiating section; and a wire heating power source that electrifies the welding wire so that the welding wire located in the melted portion of the base material surface is almost melted. In the case of thick plate welding, it is possible to improve operating efficiency and working accuracy, and in the case of welding a hard-to-weld material such as a high-tensile steel board, it is possible to perform welding while preventing deterioration and fracture of metal structure from occurring.

### TECHNICAL FIELD

The present invention relates to a hybrid welding method and apparatus suitable to be used for thick plate welding, overlay welding, and welding applied to a hard-to-weld material such as a high-tensile steel board.

### BACKGROUND ART

For the thick plate welding and the welding applied to a hard-to-weld material such as a high-tensile steel board, for example, a hot-wire TIG welding method has been widely used (see Non-Patent Document 1, for example). The hot-wire TIG welding method feeds TIG arc with welding wire heated by being electrified, and it makes up for the small weld volume of regular TIG welding.

### PRIOR ART DOCUMENT

### Non-Patent Document

Non-Patent Document 1: Welding and Joining Handbook edited by Japan Welding Society, second edition, 902 pages

### SUMMARY OF THE INVENTION

### Problems to be Solved by the Invention

If the hot-wire TIG welding method is used for thick plate welding, the amount of heat inputted to a welding spot by TIG arc becomes large, and a base material is then distorted. In other words, the hot-wire TIG welding method has the problem that it requires a process for eliminating distortion and also causes a deterioration in working accuracy. According to the hot-wire TIG welding method, if plate thickness is increased to prevent the distortion of the base material, this entails a weight increase.

Another problem is that, when the hot-wire TIG welding method is used for welding a hard-to-weld material such as a high-tensile steel board, the base material is greatly affected by heat as a result of heat input into a welding spot using TIG arc as in the above-mentioned case, and this leads to a deterioration or fracture in metal structure. It has then been an issue to solve these problems.

It is an object of the invention to provide a hybrid welding method and apparatus with which it is possible, when used for thick plate welding, to improve operating efficiency and working accuracy without a weight increase due to the capability of reducing a distortion amount of a base material.

It is also an object of the invention to provide a hybrid welding method and apparatus with which it is possible, when used for welding a hard-to-weld material such as a high-tensile steel board, to perform high-quality welding while preventing deterioration and fracture of metal structure from occurring.

### Means for Solving the Problems

In order to accomplish the above objects, the inventors recognized the importance of a laser diode that is a type of laser used for laser welding.

The laser diode is a type of laser with quite a high lasing efficiency. The uses of the laser diode, however, are limited to surface modification and the like. This is because the laser diode is designed to integrate elements in arrays to gain a high output power, and is limited in light focusing performance unlike YAG lasers or the like.

On the other hand, the laser diode has excellent irradiation uniformity and enables an accurate control of heat input applied to a base material. Based upon these factors, the inventors gained the knowledge that if the heat conduction welding is performed by using the laser diode, it is possible to thinly and uniformly melt a wide area of the base material surface.

The inventors thus found that high-quality welding can be achieved if the heat conduction welding using the laser diode is performed to uniformly and minimally heat the base material to melt the surface and vicinity thereof, and welding wire (hot wire) heated until almost melted is fed to the melted portion and is then minimally heated and melted by being electrified and applied with the laser diode.

In other words, the inventors found that, if both the laser diode and the hot wire are used to separate a heat source for heating the base material from that for heating the welding wire, it is possible to accomplish conditions for a stable low heat-input welding that is required for the thick plate welding and the welding applied to a hard-to-weld material such as a high-tensile steel board. The inventors thus made the present invention.

The invention is characterized in that, at the time of the thick plate welding and the welding applied to a hard-to-weld material such as a high-tensile steel board, a laser beam emitted from the laser diode is focused on and thus melts the surface of the base material while being moved, and welding wire with a diameter, for example, of 1.2 mm, which is almost melted by being electrified, is continuously fed to a melted portion of the surface of the base material moving along with the movement of the laser beam (claim 1).

According to the invention, the shape of the laser beam spot on the surface of the base material is not particularly limited. For instance, the spot may have a circular, oval or rectangular shape. The length of the spot in a direction orthogonal to the moving direction of the laser beam is defined as spot width (defined as spot diameter if the spot has a circular shape).

Preferably, the laser beam spot on the surface of the base material has a spot width ranging from 5 mm to 11 mm (a spot diameter ranging from 5 mm to 11 mm if the spot has a circular shape) in the direction orthogonal to the moving direction of the laser beam (claim 2).

Preferably, the laser beam spot on the surface of the base material has an oval shape elongated in the moving direction of the laser beam (claim 3).

Preferably, the laser beam spot on the surface of the base material has a shape of circles overlapping in the moving direction of the laser beam (claim 4).

Preferably, the welding wire is fed in front of the moving direction of the laser beam (claim 5).

The invention is a hybrid welding apparatus that performs thick plate welding and welding applied to a hard-to-weld material such as a high-tensile steel board, the apparatus having a laser diode; an irradiating section that applies an output from the laser diode to a base material in the form of a laser beam and thus melts the surface of the base material while moving the laser beam; a wire feeding section that continuously feeds welding wire to a melted portion of the surface of the base material moving along with the movement of the laser beam emitted from the irradiating section; and a wire heating power source that electrifies the welding wire so that the welding wire located in the melted portion of the base material surface is almost melted (claim 6).

Preferably, the spot of the laser beam emitted from the irradiating section onto the surface of the base material has a spot width ranging from 5 mm to 11 mm (a spot diameter ranging from 5 mm to 11 mm if the spot has a circular shape) (claim 7).

Preferably, the apparatus has spot-shape changing means that elongates the spot of the laser beam emitted from the irradiating section onto the surface of the base material so that the spot has an oval shape elongated along the moving direction of the laser beam (claim 8).

Preferably, the apparatus has spot-shape changing means that forms the shape of the spot of the laser beam emitted from the irradiating section onto the surface of the base material so that the spot has a shape of circles overlapping in the moving direction of the laser beam (claim 9).

If the spot width is smaller than 5 mm, heat input does not stop at the surface of the base material and the vicinity thereof but reaches all the way inside the base material. A spot width larger than 11 mm causes insufficient weld penetration. Consequently, the spot width preferably ranges from 6 mm to 10 mm, and further preferably from 7 mm to 9 mm.

In the hybrid welding method and apparatus according to the invention, the laser beam spot on the base material surface may be divided into parts along the moving direction of the laser beam so that each part has predetermined irradiation intensity.

In the hybrid welding method and apparatus according to the invention, pressure-controlling means such as an actuator may be provided to maintain a constant contact pressure of the welding wire against the base material surface.

In the hybrid welding method and apparatus according to the invention, an oscillation mechanism for the laser beam and the welding wire may be provided to oscillate the laser beam and the welding wire with amplitude equal to or less than groove width and in cycles equal to or less than predetermined cycles at the time of butt welding.

The hybrid welding method and apparatus according to the invention are suitable to be used for fillet welding of steel members, or so-called composite floor boards, in a steel-concrete composite structure of a construction formed of a steel board or high-tensile steel board with a plate thickness ranging from 5 mm to 8 mm, which is for example a bridge and an express highway, and are also suitable to be used for fillet welding of a ship superstructure.

In the hybrid welding method and apparatus according to the invention, when the laser beam emitted from the laser diode is focused on the base material, the base material is uniformly exposed to a minimum amount of heat, and only the surface and vicinity thereof are melted.

If, in this state, the melted portion of the surface of the base material moving along with the movement of the laser beam is heated by the laser beam while the welding wire electrified into an almost melted state is continuously fed to the melted portion, the welding wire is exposed to a minimum amount of heat and is thus melted, leading to high-quality welding.

If the spot diameter of the laser beam on the base material surface ranges from 5 mm to 11 mm (preferably from 6 mm to 10 mm, and further preferably from 7 mm to 9 mm), welding wire can be fed to an area in which there is not much irregularity of melting in the base material surface, including unevenness, roughness and the like, resulting in highly stable welding.

In the hybrid welding method and apparatus according to the invention, if the laser beam spot on the base material surface has an oval shape elongated in the moving direction of the laser beam or a shape of circles overlapping in the moving direction of the laser beam, more highly stable welding is achieved.

Furthermore, in the hybrid welding method and apparatus according to the invention, if the welding wire is fed in front of the moving direction of the laser beam, the laser beam inevitably follows the welding wire. In this manner, defects in weld beads are mended, including a failure of welding of the welding wire and the like.

### Advantages of the Invention

The hybrid welding method and apparatus according to the invention are capable of reducing a heat affect on the base material. Consequently, if the method and apparatus are used in thick plate welding, a distortion amount of the base material is almost zero, thus bringing the excellent advantage of improving operating efficiency and working accuracy without increasing weight.

If the hybrid welding method and apparatus according to the invention are used to weld a hard-to-weld material such as a high-tensile steel board, this brings the excellent advantage that high-quality welding can be performed while preventing a deterioration and fracture from being caused in metal structure.

### BRIEF DESCRIPTION OF THE DRAWINGS

FIG. 1 is an explanatory view showing the configuration of a hybrid welding apparatus according to one embodiment of the invention;

FIG. 2 is a cross-sectional view for explaining a situation in which fillet welding is performed by using the hybrid welding apparatus shown in FIG. 1;

FIG. 3 is a magnified photograph showing a portion subjected to fillet welding using the hybrid welding apparatus shown in FIG. 1;

FIG. 4 is a magnified photograph showing a portion that is fillet-welded by conventional hot-wire TIG welding;

FIG. 5 is an explanatory view showing the configuration of a hybrid welding apparatus according to another embodiment of the invention;

FIG. 6 is an explanatory view of a partial configuration in which a welding torch of the hybrid welding apparatus shown in FIG. 5 is in another position;

FIG. 7 is an explanatory perspective view showing the whole length of a steel member to be installed in a steel-concrete composite structure produced by using the hybrid welding apparatus shown in FIG. 5;

FIG. 8 is a magnified photograph showing a portion subjected to fillet welding using the hybrid welding apparatus shown in FIG. 5 in a grinded region;

FIG. 9 is an explanatory perspective view of a fillet-welded portion, showing a grinded region, a shot-blasted region and a region applied with no surface treatment;

FIG. 10 is a magnified photograph showing a portion in a shot-blasted region, which has been subjected to fillet welding using the hybrid welding apparatus shown in FIG. 5;

FIG. 11 is a magnified photograph showing a portion in a region applied with no surface treatment, which has been subjected to fillet welding using the hybrid welding apparatus shown in FIG. 5; and

FIG. 12 is an explanatory perspective view showing a portion subjected to fillet welding using a hybrid welding apparatus according to another embodiment of the invention.

### BEST MODE OF CARRYING OUT THE INVENTION

The invention will be described below with reference to the attached drawings.

### Embodiment 1

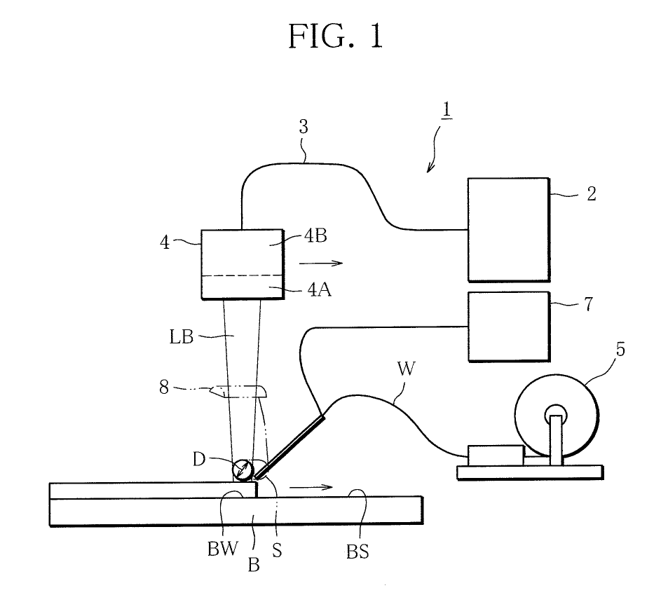

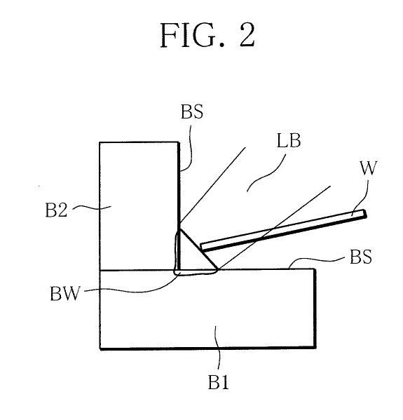

FIGS. 1 and 2 show one embodiment of a hybrid welding apparatus according to the invention.

As shown in FIG. 1, a hybrid welding apparatus 1 has a laser diode 2 and an irradiating section 4. The laser diode 2 and the irradiating section 4 are connected to each other through an optical fiber 3.

The irradiating section 4 is equipped with an irradiation head 4A and a drive unit 4B for shifting the irradiation head 4A. The irradiation head 4A converts an output transmitted from the laser diode 2 through the optical fiber 3 into a laser beam LB and focuses the laser beam LB on a base material B, to thereby melt a surface BS of the base material B.

The hybrid welding apparatus 1 further includes a wire feeder 5 and a wire heating power source 7. The wire feeder 5 continuously feeds welding wire W to a melted portion BW of the surface BS of the base material B moving along the movement of the laser beam LB emitted from the irradiation head 4A. The wire heating power source 7 electrifies the welding wire W so that an end portion of the welding wire W, which is located in the melted portion BW of the surface BS of the base material B, is almost melted.

In this situation, a spot of the laser beam LB emitted from the irradiation head 4A of the irradiating section 4, which is focused on the surface BS of the base material B, has a circular shape. A spot width in a direction orthogonal to a moving direction of the laser beam LB, namely, a spot diameter D, ranges from 5 mm to 11 mm.

As shown by an imaginary line in FIG. 1, a spot S of the laser beam LB on the surface BS of the base material B may be designed to have an oval shape elongated in the moving direction of the laser beam LB by placing a cylindrical lens (spot-shape changing means) 8 on a light path of the laser beam LB.

According to the hybrid welding apparatus 1 thus configured, for example, as shown in FIG. 2, if the laser beam LB emitted from the irradiation head 4A of the irradiating section 4 is focused on base materials B1 and B2, the base materials B1 and B2 are uniformly exposed to a minimum amount of heat and are melted only at surfaces BS and vicinities thereof.

In the next place, the drive unit 4B of the irradiating section 4 is operated to move the laser beam LB together with the irradiation head 4A. The welding wire W is continuously fed in front of the moving direction of the laser beam LB to melted portions BW in the surfaces BS of the base materials B1 and B2 moving along with the movement of the laser beam LB. The welding wire W is fed after being electrified by the wire heating power source 7 into an almost melted state.

If the almost melted welding wire W is heated by the laser beam LB, the welding wire W is melted by being exposed to a minimum amount of heat. This results in high-quality welding.

In this embodiment, the spot diameter D of the laser beam LB on the surface BS of the base material B ranges from 5 mm to 11 mm. This makes it possible to feed the welding wire W to an area in which there is not much irregularity of the melted portion BW of the base material surface BS, including unevenness, roughness and the like, leading to highly stable welding.

If the spot S of the laser beam LB on the surface BS of the base material B is designed to have an oval shape elongated along the moving direction of the laser beam LB by placing the cylindrical lens (spot-shape changing means) 8 on the light path of the laser beam LB as shown by an imaginary line in FIG. 1, welding becomes more highly stable.

Since the welding wire W is fed in front of the moving direction of the laser beam LB in this embodiment, the laser beam LB follows the welding wire W, which inevitably mends defects in weld beads, including the failure of welding of the welding wire and the like.

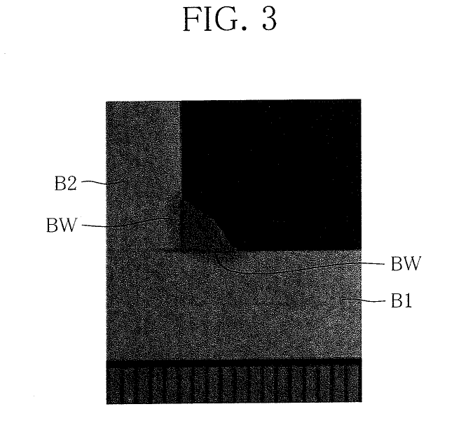

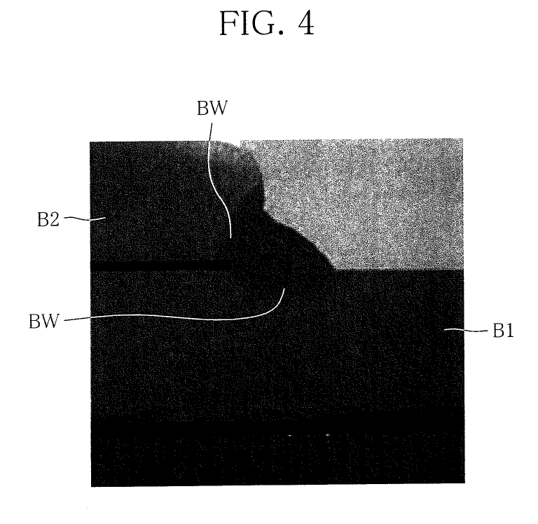

The inventors took a photo of a cross-section of the fillet-welded portion and made a comparison between this photo and a photo of a cross-section of a portion that was fillet-welded by conventional hot-wire TIG welding. They gained results shown in FIGS. 3 and 4.

As is apparent from FIGS. 3 and 4, in the fillet welding performed by the hybrid welding method and apparatus 1 according to the present embodiment, the base materials B1 and B2 were not distorted, and moreover, the melted portions BW were very shallow. On the contrary, in the fillet welding performed by the conventional hot-wire TIG welding, the base materials B1 and B2 were distorted, and the melted portions BW were deep.

It was proved that the hybrid welding method and apparatus 1 according to the present embodiment could provide high-quality welding as compared to the conventional hot-wire TIG welding.

### Embodiment 2

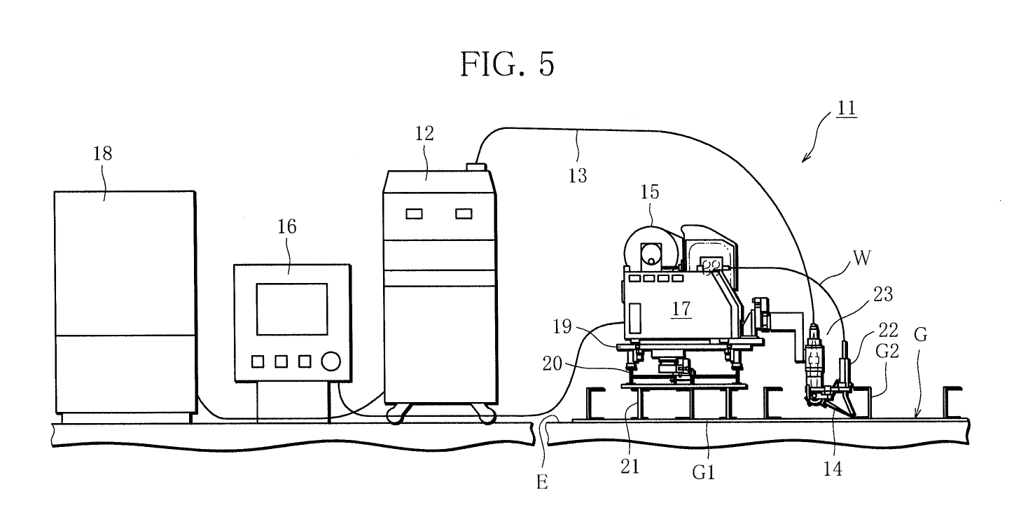

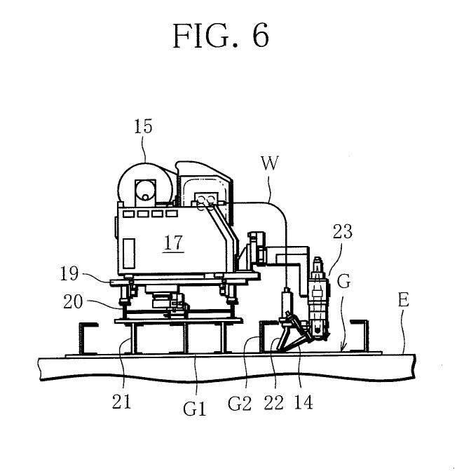

FIGS. 5 and 6 show a hybrid welding apparatus according to another embodiment of the invention. This embodiment shows a situation in which the hybrid welding apparatus of the invention is used in fillet welding, and more specifically, used in fillet welding for producing steel members (so-called composite floor boards) in a steel-concrete composite structure, such as a bridge and an express highway.

As shown in FIG. 5, the hybrid welding apparatus 11 has a laser diode 12, a welding torch (irradiating section) 14, a wire feeder 15, a controller 16, a wire heating power source 17, a chiller 18, and a welding wagon 19.

The laser diode 12, the controller 16 and the chiller 18 are all placed on a base E. The welding torch 14, the wire feeder 15 and the wire heating power source 17 are all placed on the welding wagon 19.

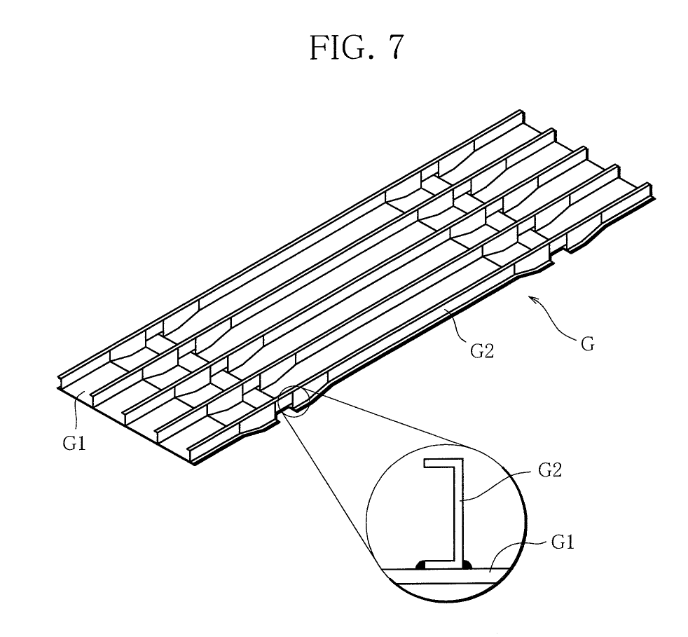

As shown in FIG. 7, a steel member G is formed by arranging a plurality of channel members G2 parallel to each other on a steel board G1 (steel board with a thickness of approximately 8 mm). In this embodiment, a rail 20 is placed on the steel board G1 with a bottom 21 intervening therebetween. The rail 20 is parallel with the channel members G2 to be fillet-welded to the steel board G1. The welding wagon 19 travels on the rail 20 at a constant velocity that does not exceed 2 m/min.

A maximum output of the laser diode 12 is 6 kW. The welding torch 14 focuses a laser beam from the laser diode 12, which is transmitted through the optical fiber 13 with a wire diameter of 1 mm, on the steel board G1 and thus melts the surface thereof.

The wire feeder 15 continuously feeds welding wire W to a melted portion of the steel board G1 moving along the movement of the laser beam emitted from the irradiation torch 14. The wire heating power source 17 heats the welding wire W by supplying the welding wire W with a current of up to 300A and brings the end portion of the welding wire W, which is located in the melted portion of the steel board G1, into an almost melted state.

In this case, the welding wagon 19 is provided with a wire guide 22 that directs the end portion of the welding wire W to the melted portion of the steel board G1. The welding wagon 19 is further provided with a swing gear 23 that supports the welding torch 14 and the wire guide 22. The swing gear 23 supports the welding torch 14 and the wire guide 22 so that both of them are directed towards a fillet-welded portion and also supports the welding torch 14 and the wire guide 22 so that they may swing around a vertical axis. Once the swing gear 23 is operated, the welding torch 14 and the wire guide 22 are shifted from welding positions shown in FIG. 5 to those shown in FIG. 6 while maintaining their positional relationship.

The spot of the laser beam emitted from the welding torch 14 is set into a circular shape by using an optical lens built in the welding torch 14. For example, in consideration of leg length of the fillet welded portion, light is collected so that spot width in a direction orthogonal to the moving direction of the laser beam, namely, spot diameter, falls in a range of from 5 mm to 11 mm. The laser beam is emitted from diagonally above so that an optical axis thereof is directed towards a weld line of the fillet-welded portion.

The welding wire W is fed in front of the moving direction of the welding and from diagonally above. The welding wire W is adjusted so that the end portion the welding wire W is located on an anteriormost portion, as viewed in the moving direction, of the laser beam spot at which light is collected.

When the hybrid welding apparatus 11 thus configured is used to fillet-weld the channel members G2 to the steel board G1, joint surfaces of the steel board G1 and the channel members G2 are firstly grinded and smoothed. The laser beam emitted from the welding torch 14 is then focused on the steel board G1 and the channel members G2. Both the steel board G1 and the channel members G2 are uniformly exposed to a minimum amount of heat, and only the surfaces and vicinities thereof are melted.

The laser beam is moved together with the welding torch 14 by the welding wagon 19 travelling at constant velocity. The welding wire W is continuously fed in front of the moving direction of the laser beam to the melted portions of the surfaces of the steel board G1 and the channel members G2 moving along with the movement of the laser beam. During this process, the welding wire W is fed in a state almost melted by being electrified by the wire heating power source 17.

If the almost-melted welding wire W is then heated by the laser beam, the wire W is exposed to a minimum amount of heat and thus melted, leading to high-quality welding.

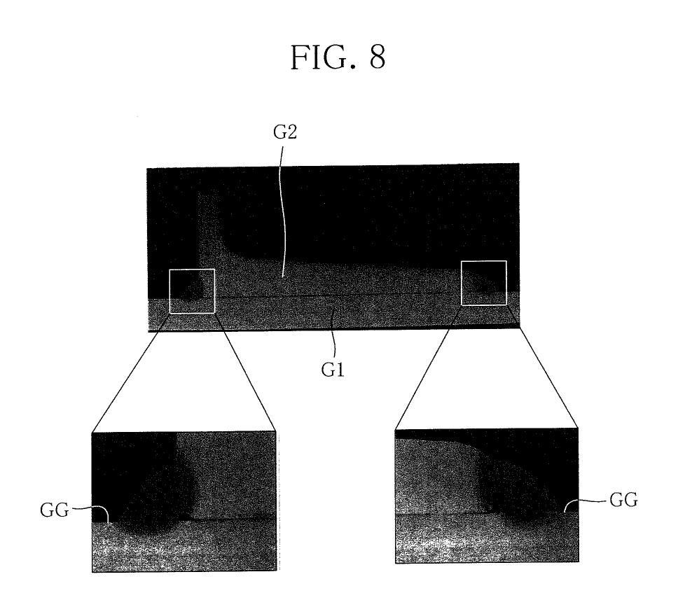

The inventors took a photo of the cross-section of the fillet-welded portion in the case where the channel members G2 were fillet-welded to the steel board G1 by using the hybrid welding apparatus 11, and gained a result as shown in FIG. 8. The fillet welding was performed under conditions that a laser output fell in a range from 4 kW to 6 kW, a welding rate from 0.8 m/min to 1.2 m/min, a wire feeding rate from 8 m/min to 12 m/min, and a wire feeding current from 175 A to 205 A.

As is obvious from FIG. 8, in the fillet welding by the hybrid welding method and apparatus 11 according to the present embodiment, the steel board G1 and the channel members G2 are not distorted, and the welded portion is very shallow. It was thus proved that the hybrid welding method and apparatus 11 according to the present embodiment could provide the steel member G with high quality.

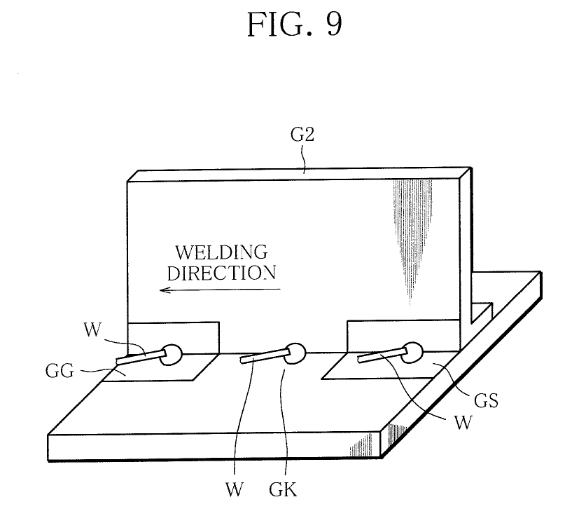

As shown in FIG. 9, the above embodiment carries out the fillet welding after applying the grinding process to the joint surfaces of the steel board G1 and the channel members G2 and thus creating flat and smooth faces GG.

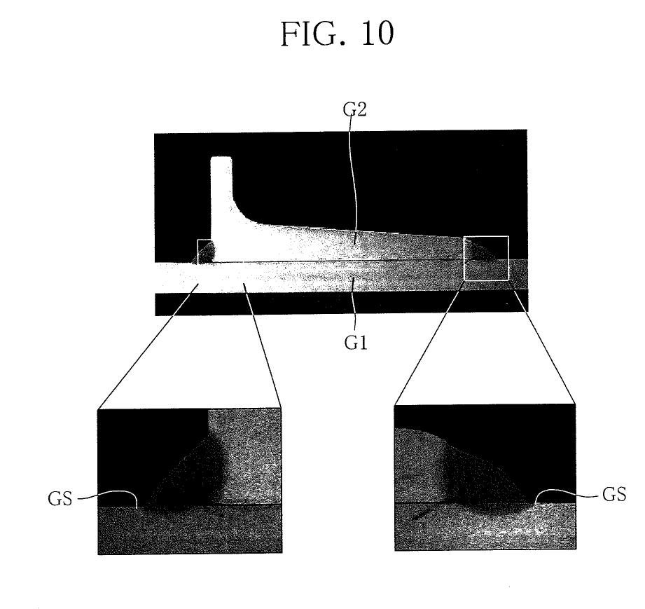

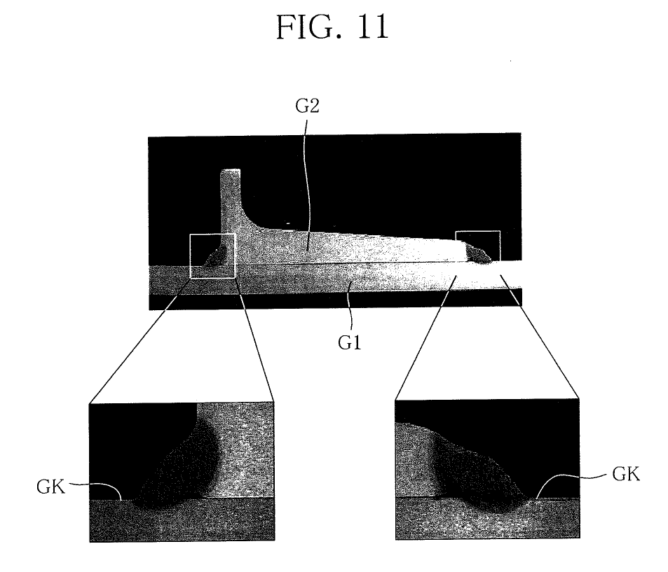

The inventors took photos of cross-sections of fillet-welded portions in the case where fillet welding is performed after flat and smooth faces GS are created by applying shot blasting process to the joint surfaces of the steel board G1 and the channel members G2 and the case where fillet welding is applied to the joint surfaces of the steel board G1 and the channel members G2, that is, untreated faces GK, instead of proving surface treatment to the joint surfaces, and gained results as shown in FIGS. 10 and 11. As in the case where the grinding process was performed, the above-described fillet welding was also carried out under conditions that a laser output fell in a range from 4 kW to 6 kW, a welding rate from 0.8 m/min to 1.2 m/min, a wire feeding rate from 8 m/min to 12 m/min, and a wire feeding current from 175 A to 205 A.

As is clear from FIGS. 10 and 11, both in the case where the flat and smooth face GS is created by applying the shot blasting process and the case where the joint surface remains as the untreated face GK without surface treatment, the fillet welding by the hybrid welding apparatus 11 does not distort the steel board G1 and the channel members G2 and forms very shallow welded portions. The hybrid welding method and apparatus 11 of this embodiment allow to properly choose surface treatment to be applied to the joint surfaces of the steel board G1 and the channel members G2 (including not providing any surface treatment). This reduces the number of welding processes and the cost for welding.

### Embodiment 3

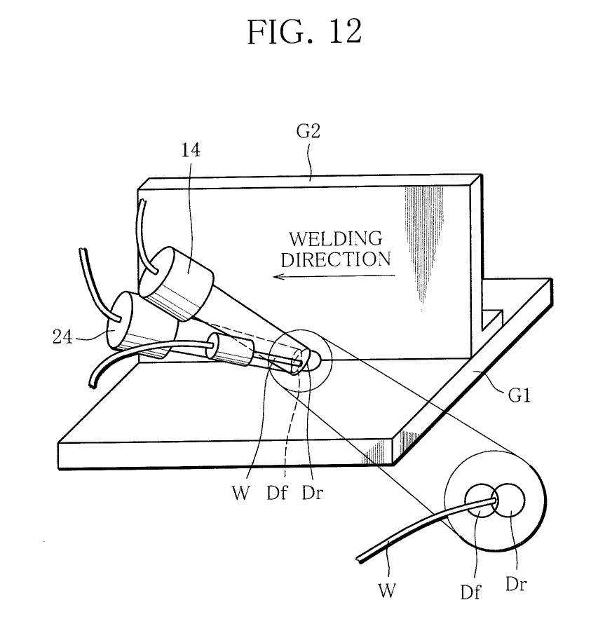

FIG. 12 shows a hybrid welding method according to another embodiment of the invention. As shown in FIG. 12, the hybrid welding method of this embodiment differs from the method of the foregoing embodiments is that, in addition to the welding torch 14, a welding torch (spot-shape changing means) 24 is placed near the anteriormost portion of the welding torch 14 (near the left side in the drawing) as viewed in the moving direction of the welding torch 14.

In other words, according to the hybrid welding method of this embodiment, a circular spot Df of a laser beam emitted from the welding torch 24 is positioned to overlap the anteriormost portion (left side in the drawing), as viewed in the moving direction, of a circular spot Dr of a laser beam emitted from the welding torch 14. The spots Dr and Df may have an oval shape.

According to the hybrid welding method of the present embodiment, the spot Df of the laser beam emitted from the welding torch 24 located on the anteriormost portion of the spot Dr as viewed in the moving direction of the spot Dr preheats the surface of the steel board G1 prior to the movement of the spot Dr and thus removes dust on the surface of the steel board G1 and absorption gas. In result, the welding wire W is more surely electrified. It is then possible to avoid the failure of connection between the welding wire W and the steel board G1, which is caused when dust and absorption gas are stirred up during rapid heating, thereby stabilizing the quality of welding.

In the present embodiment, the spot Df is formed by providing the welding torch 24 serving as spot-shape changing means apart from the welding torch 14. However, the way of forming the spot Df is not limited to this. In another possible configuration, the laser beam is divided within the welding torch 14 to form the spot Df. Methods used in this case include a method that transmits the laser beam through the optical lens in the welding torch 14 by using a light polarizer and then slightly polarizes a propagation direction, and another method that fixes a partial reflection mirror to the optical lens in the welding torch 14 at a spot where light is parallelized, and determines transmittance ratio by selecting the transmission of the partial reflection mirror.

The above-mentioned embodiments feed the welding wire in front of the moving direction of the laser beam, but instead may feed behind the moving direction of the laser beam.

### REFERENCE MARKS

1 hybrid welding apparatus
2 laser diode
4 irradiating section
5 wire feeder
7 wire heating power source
9 cylindrical lens (spot-shape changing means)
11 hybrid welding apparatus
12 laser diode
14 welding torch (irradiating section)
15 wire feeder
17 wire heating power source
24 another welding torch (spot-shape changing means)
B base material
BS base material surface
BW melted portion of the surface
LB laser beam
G1 steel board (base material)
channel member (base material)
W welding wire

1. A hybrid welding method of carrying out thick plate welding and welding applied to a hard-to-weld material such as a high-tensile steel board, the method wherein:
at the time of the thick plate welding and the welding applied to a hard-to-weld material such as a high-tensile steel board,
a laser beam emitted from the laser diode is focused on and thus melts the surface of the base material while being moved; and
welding wire that is almost melted by being electrified is continuously fed to a melted portion of the surface of the base material moving along with the movement of the laser beam.

2. The hybrid welding method according to claim 1, wherein a laser beam spot on the surface of the base material has a spot width ranging from 5 mm to 11 mm in a direction orthogonal to the moving direction of the laser beam.

3. The hybrid welding method according to claim 1, wherein the laser beam spot on the surface of the base material has an oval shape elongated in the moving direction of the laser beam.

4. The hybrid welding method according to claim 1, wherein the laser beam spot on the surface of the base material has a shape of circles overlapping in the moving direction of the laser beam.

5. The hybrid welding method according to claim 1, wherein the welding wire is fed in front of the moving direction of the laser beam.

6. A hybrid welding apparatus that performs thick plate welding and welding applied to a hard-to-weld material such as a high-tensile steel board, comprising:
a laser diode;
an irradiating section that applies an output from the laser diode to a base material in the form of a laser beam and thus melts the surface of the base material while moving the laser beam;
a wire feeding section that continuously feeds welding wire to a melted portion of the surface of the base material moving along with the movement of the laser beam emitted from the irradiating section; and
a wire heating power source that electrifies the welding wire so that the welding wire located in the melted portion of the base material surface is almost melted.

7. The hybrid welding apparatus according to claim 6, wherein the spot of the laser beam emitted from the irradiating section onto the surface of the base material has a spot width ranging from 5 mm to 11 mm.

8. The hybrid welding apparatus according to claim 6, having spot-shape changing means that elongates the spot of the laser beam emitted from the irradiating section onto the surface of the base material so that the spot has an oval shape elongated along the moving direction of the laser beam.

9. The hybrid welding apparatus according to claim 6, having spot-shape changing means that forms the shape of the spot of the laser beam emitted from the irradiating section onto the surface of the base material so that the spot has a shape of circles overlapping in the moving direction of the laser beam.
